(19) United States
(12) Patent Application Publication
(10) Pub. No.: US 2026/0365883 A1
(43) Pub. Date: Nov. 19, 2026

(54) ADHESIVE PROTECTIVE FILM, OPTICAL MEMBER AND OPTICAL DISPLAY APPARATUS

(71) Applicant: SAMSUNG SDI CO., LTD., Yongin-si (KR)

(72) Inventors: Ju Yeol CHOI, Suwon-si (KR); Won KIM, Suwon-si (KR); Young Hoon KIM, Suwon-si (KR); Nak Hyun SUNG, Suwon-si (KR); Il Jin KIM, Suwon-si (KR)

(21) Appl. No.: 19/374,277

(22) Filed: Oct. 30, 2025

(30) Foreign Application Priority Data
Apr. 30, 2025 (KR) 10-2025-0057452

(51) Int. Cl. C09J 7/30; B32B 7/06; B32B 7/12; B32B 27/08; B32B 27/28; B32B 27/36; C09J 7/29

(52) U.S. Cl. CPC C09J 7/30; B32B 7/06; B32B 7/12; B32B 27/08; B32B 27/281; B32B 27/36; C09J 7/29; B32B 2307/536; B32B 2307/584; B32B 2307/7376; B32B 2405/00; B32B 2457/20; C09J 2203/326; C09J 2301/162; C09J 2301/41; C09J 2301/416; C09J 2475/00; C09J 2479/088

(57) ABSTRACT

There are provided an adhesive protective film, an optical member, and an optical display apparatus. The adhesive protective film includes a substrate layer, an adhesive film formed on a first surface of the substrate layer, and a protective layer formed on a second surface of the substrate layer, the adhesive film includes a (meth)acrylic copolymer, a curing agent, an aromatic group-containing monofunctional or higher monomer, and an initiator, and the protective layer contains a silicon-based compound and has a pencil hardness value of F to H and a water contact angle value of 90° to 100° at 23 °C.

### CROSS-REFERENCE TO RELATED APPLICATION

The present application claims priority to and the benefit of Korean Patent Application No. 10-2025-0057452, filed on Apr. 30, 2025, in the Korean Intellectual Property Office, the entire disclosure of which is incorporated herein by reference.

### BACKGROUND

### 1. Field

One or more aspects of embodiments of the present invention are directed to an adhesive protective film, an optical member, and an optical display apparatus.

### 2. Description of the Related Art

In devices such as optical and/or electronic members, a protective film including (e.g., consisting of) an adhesive layer alone, or including a substrate film and an adhesive layer, is sometimes attached to the surface of the device so as to prevent or reduce scratching of the surface of the device during processes such as processing, assembly, inspection, and/or the like. The protective film is utilized after removing a release film that protects the adhesive layer. In recent years, a transition from liquid crystal devices to organic light-emitting diode (OLED) devices as optical members has been on-going. Also, the number of OLED devices having flexible characteristics has been increasing.

Flexible OLED devices are significantly more flexible than liquid crystal devices and/or conventional OLED devices. Therefore, the flexible OLED devices require (or desire) a processing protective film to prevent or reduce the scratching of the surface and/or to protect the OLED panel during processes such as processing, assembly, inspection, and/or the like. When there are defects such as an abnormal appearance, foreign matter, and/or the like during panel inspection, suitably low peel strength and reworking characteristics are desired or required to easily remove the protective film. After the inspection is completed, a permanently attached patterned film (P-film) is desired or required to support the panel and protect the panel from moisture and the external environment. Because the P-film must be permanently attached to the panel, suitably high peel strength and reliability of the P-film are desired or required.

Therefore, because a processing protective film having suitably low peel strength, which is temporarily used, and a P-film having a suitably high peel strength are desired or required in the process of manufacturing a panel, a process of laminating a processing protective film, a process of peeling the processing protective film, and a process of laminating a P-film are desired or required.

The process of manufacturing an OLED device having flexible characteristics using a patterned film should be easily understood by those of ordinary skill in the art. FIG. 1 is a diagram illustrating a part of a process of assembling a panel for an optical display apparatus using an adhesive protective film of related art.

Referring to FIG. 1, a temporary upper protective film 2 and a temporary lower protective film 3 are laminated on the upper and lower surfaces of a panel 1 (e.g., a polyimide-based panel) on which an OLED light-emitting element is formed, respectively, to manufacture a laminate (I). The laminate is cut with a laser 4 to separate the laminate (II). A portion is separated from the laminate with a laser 5 to obtain a laminate having a small size (a temporary upper protective film 2a and a temporary lower protective film 3a are laminated on the upper and lower surfaces of the panel 1a on which an OLED light-emitting element is formed, respectively) (III). The temporary lower protective film 3a is removed from the laminate, and a portion of the temporary upper protective film 2a is removed (IV). A laminate of a patterned film 8 and a carrier film 6 is laminated on the lower surface of the panel 1a on which an OLED light-emitting element is formed (V). Then, a display driver 9 may be mounted to manufacture a panel having a display area and a non-display area formed thereon (VI).

The carrier film 6 may serve to protect the patterned film 8. Because the carrier film 6 serves to protect the patterned film, it is not involved in the actual panel manufacturing process. Therefore, the development of a patterned film that does not use the carrier film 6 is in progress.

The background of the present invention is disclosed in Japanese Patent No. 5683369, and the like.

### SUMMARY

One or more aspects of embodiments of the present disclosure are directed to providing an adhesive protective film capable of enhancing the durability reliability of a polyimide-based optical element having polyimide-based ash, where the adhesive protective film is adhered to the polyimide-based optical element, has a significantly higher peel strength after light irradiation than before light irradiation, and is fixed to the optical element.

One or more aspects of embodiments of the present disclosure are also directed to providing an adhesive protective film that can be concurrently (e.g., simultaneously) used as a temporary processing protective film in the manufacture of a flexible light-emitting element panel and as a pattern-reinforcing protective film having only a portion selectively peeled off to form a pattern.

Further, one or more aspects of embodiments of the present disclosure are directed to providing an adhesive protective film having excellent or suitable scratch resistance and excellent or suitable panel manufacturing processability, when using the adhesive protective film.

According to one or more embodiments of the present disclosure, there is provided an adhesive protective film that includes a substrate layer, an adhesive film formed on a first surface of the substrate layer, and a protective layer formed on a second surface of the substrate layer, wherein the adhesive film includes a (meth)acrylic copolymer, a curing agent, an aromatic group-containing monofunctional or higher monomer, and an initiator, and the protective layer contains a silicon-based compound and has a pencil hardness value of F to H and a water contact angle value of 90° to 100° at 23 °C.

According to one or more embodiments of the present disclosure, there is provided an optical member that includes a polyimide-based optical element having polyimide-based ash on at least one surface, and an adhesive protective film laminated on the one surface having the polyimide-based ash, wherein the adhesive protective film includes a substrate layer, an adhesive film laminated on a first surface of the substrate layer, and a protective layer laminated on a second surface of the substrate layer, the adhesive film includes a cured product of a composition including a (meth)acrylic copolymer, a curing agent, an aromatic group-containing monofunctional or higher monomer, and an initiator, and the protective layer contains a silicon-based compound and has a pencil hardness value of F to H and a water contact angle value of 90° to 100° at 23 °C.

According to one or more embodiments of the present disclosure, there is provided an optical display apparatus including the optical member.

### BRIEF DESCRIPTION OF THE DRAWINGS

The above and other objects, features and advantages of the present disclosure will become more apparent to those of ordinary skill in the art by describing example embodiments thereof in more detail with reference to the accompanying drawings, in which:

FIG. 1 is a diagram illustrating a part of a process of assembling a panel for an optical display apparatus using a related art adhesive protective film;

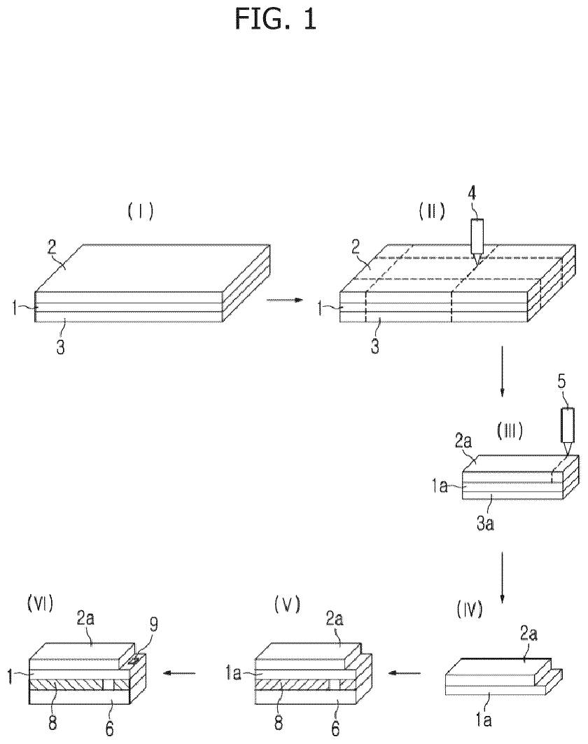

FIG. 2 is a cross-sectional view of an adhesive protective film according to one or more embodiments;

FIG. 3 is a cross-sectional view of an adhesive protective film according to one or more other embodiments;

FIG. 4 is a diagram illustrating a part of a process of assembling a panel for an optical display apparatus using the adhesive protective film according to one or more embodiments;

FIG. 5 illustrates one or more embodiments of a method of manufacturing a polyimide-based layer having polyimide-based ash;

FIG. 6 illustrates one or more other embodiments of a method of manufacturing a polyimide-based layer having polyimide-based ash; and

FIG. 7 is a cross-sectional view of one or more embodiments of an optical member.

### DETAILED DESCRIPTION

The present disclosure will be described in more detail with reference to the example embodiments so that those skilled in the art can easily practice the present invention. The present disclosure may be implemented in one or more different suitable forms and is not intended to limit the embodiments described herein.

The terminology disclosed herein is used for the purpose of describing example embodiments only and is not intended to limit the present disclosure. The singular expression includes the plural expression unless the context clearly indicates otherwise.

In the present specification, the term “(meth)acrylic” may refer to acrylic and/or methacrylic.

In the present specification, the term “copolymer” may include a polymer and/or a resin.

When describing a numerical range in the present specification, the term “X to Y” refers to X or more and Y or less (X≤ and ≤Y). Further, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It will be understood that, although the terms first, second, etc. may be used herein to describe various elements, these elements should not be limited by these terms. These terms are only used to distinguish one element from another element. Thus, a first element could be termed a second element without departing from the teachings of the present invention. Similarly, a second element could be termed a first element.

It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As used herein, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from among a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items.

Further, the use of “may” when describing embodiments of the present disclosure refers to “one or more embodiments of the present disclosure”.

It will be understood that when an element is referred to as being “on,” “connected to,” or “coupled to” another element, it may be directly on, connected, or coupled to the other element or one or more intervening elements may also be present. When an element is referred to as being “directly on,” “directly connected to,” or “directly coupled to” another element, there are no intervening elements present.

Spatially relative terms, such as “beneath,” “below,” “lower,” “above,” “upper,” “bottom,” “top” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The electronic device and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

A person of ordinary skill in the art would appreciate, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

An adhesive protective film according to one or more example embodiments includes a substrate layer, an adhesive film provided (e.g., laminated) on a first surface of the substrate layer, and a protective layer provided (e.g., laminated) on a second surface of the substrate layer.

The first and second surfaces may face each other.

The adhesive film may be in a state before light irradiation and may be a thermally cured product of a composition for an adhesive film described in more detail.

The adhesive film may be adhered to the surface having polyimide-based ash, before light irradiation, to temporarily protect the surface having the polyimide-based ash. For example, the adhesive film may prevent or reduce scratches from occurring on the surface having the polyimide-based ash during processes such as processing, assembly, inspection, and/or the like. In some embodiments, the adhesive film may be adhered to the surface having the polyimide-based ash without (or substantially without) generating bubbles.

The adhesive film may be an adhesive film whose peel strength can vary due to light irradiation. After light irradiation, the adhesive film adheres to the surface having the polyimide-based ash with a higher peel strength than before light irradiation, thereby enhancing the durability and reliability of a polyimide-based optical element.

The “polyimide-based optical element” may be a polymer film that is processed through a polymerization reaction from polyamic acid, which is a precursor, and that contains an imide group and an aromatic group in the repeating unit. The polyimide-based optical element has excellent or suitable mechanical properties and heat resistance properties, and thus may be used as a substrate for a flexible OLED panel.

In one or more embodiments, the polyimide-based optical element may be in the form of a polyimide-based layer. A method of manufacturing a polyimide-based layer having a surface having the polyimide-based ash is described in more detail herein below.

The protective layer may be continuously (e.g., substantially continuously) exposed during a process of assembling a panel using the adhesive protective film by being laminated on the second surface of the substrate layer. In such cases, scratches, marks, and/or the like may occur on the protective layer due to contact with an external foreign substance while the protective layer is transferred during the process. This may interfere with the continuous performance of the panel assembly process. Also, if (e.g., when) the adhesive protective film is permanently laminated on the panel by irradiating the adhesive protective film with light (e.g., by curing the adhesive protective film), the quality of the panel may deteriorate.

Hereinafter, an adhesive protective film of one or more embodiments will be described.

### Protective Layer

A protective layer may be laminated on a second surface of a substrate layer to protect an adhesive protective film from external foreign substances, impact, and/or contact.

The protective layer may be directly formed on the second surface of the substrate layer. Here, “directly formed” refers to embodiments in which no adhesive layer or pressure-sensitive adhesive layer is formed between the second surface of the substrate layer and the protective layer.

In one or more embodiments, the protective layer may be a coating layer formed on the second surface of the substrate layer.

For example, the protective layer may be formed by a curing process after the second surface of the substrate layer is coated with a composition for a protective layer. The curing may be, for example, ultraviolet curing and/or thermal curing. The composition for a protective layer may include a binder and a silicon-based compound.

The silicon-based compound refers to a compound containing silicon (Si) in the structure thereof, and may be in the form of a compound having a siloxane (Si—O—Si) structure, in which silicon (Si) and oxygen (O) are bonded as a basic skeleton structure, and having one or more suitable organic groups bonded thereto. For example, the silicon-based compound may be in the form of polydimethylsiloxane (PDMS), a silane coupling agent, and/or a silicone resin, but these are merely examples and embodiments are not limited thereto. The silicon-based compound may contain one or more suitable functional groups in its structure. From the viewpoint of enhancing scratch resistance, for example, the silicon-based compound may contain a multifunctional acrylic group in its structure.

The protective layer may improve scratch resistance while maintaining a certain level of adhesive strength, and may further contribute to securing stability during the panel manufacturing process and reliability of the final product, by containing a silicon-based compound. In one or more embodiments, the protective layer may improve the appearance quality and optical uniformity of the protective layer by containing a silicon-based compound.

For example, the silicon-based compound may be included in the composition for a protective layer in an amount of 0.1 to 0.4% by weight, and may be included within the above range, for example, at 0.1 to 0.3% by weight, 0.1 to 0.25% by weight, 0.1 to 0.24% by weight, or 0.12 to 0.24% by weight. In this case, the protective layer may secure a suitable level of mechanical strength sufficient to sufficiently or suitably protect the outer surface of the adhesive protective film. Accordingly, the adhesive protective film according to one or more embodiments of the present disclosure may ensure or improve process stability by preventing or reducing scratches from occurring on the outer surface of the film even without adding a separate carrier film to the outermost layer.

However, the adhesive protective film according to the present disclosure may also be used if (e.g., when) it is accompanied by a carrier film on the outermost layer. The adhesive protective film according to one or more other embodiments of the present disclosure further includes a carrier film formed on the protective layer. In this case, the peel strength between the added carrier film and the protective layer may satisfy a set or predetermined level, thereby enabling the detachment of the carrier film if (e.g., when) necessary or desired. From this perspective, the peel strength of the carrier film according to one or more embodiments may be 7 to 15 gf/inch, and may be 8 to 14 gf/inch or 9 to 13 gf/inch within the above range.

Any suitable binder may be used as the binder included in the composition for a protective layer as long as it does not negatively affect the haze and total light transmittance of the adhesive protective film. For example, the binder may include at least one selected from among a urethane-based resin and a urethane (meth)acrylate-based resin, but the present disclosure is not limited thereto.

The composition for a protective layer may further include a diluent and an initiator. For example, a diluent such as triethylene glycol dimethacrylate may be used as the diluent. The initiator may be a photoinitiator, and may be an initiator including an azo-based polymerization initiator; and/or a peroxide such as benzoyl peroxide and/or acetyl peroxide.

The composition for a protective layer may further include a solvent. The solvent may enhance the coating properties of the composition to provide a protective layer having a suitably thin thickness and a substantially uniform surface. The solvent may include one or more types (kinds) of solvents suitable in the art. For example, the solvent may include methyl ethyl ketone, methyl isobutyl ketone, ethyl acetate, toluene, and/or the like, but the present disclosure is not limited thereto. In one or more embodiments, the composition may include the adhesive protective film at a solid content (e.g., amount) of 15% by weight to 40% by weight, for example, 20% by weight to 30% by weight. Within the above range, the composition may have excellent or suitable coating properties.

The protective layer has a pencil hardness value of F to H and a water contact angle value of 90° to 100° at 23 °C. Therefore, the protective layer may provide an adhesive protective film that has excellent or suitable scratch resistance, may improve the panel manufacturing processability using the adhesive protective film, and may improve the quality of the panel.

In the present specification, pencil hardness may be defined as a grade of the hardest pencil that does not leave marks on the surface of a sheet including the adhesive protective film if (e.g., when) the surface of the sheet is scratched with the pencil lead at a constant load. For example, the pencil hardness may be a measure of the scratch resistance of the surface of the sheet including the adhesive protective film. For example, the hardness of the pencil may be expressed as a grade such as H (Hard), F (Firm), B (Black), and/or the like. For example, the pencil hardness H may be harder than the pencil hardness F and the pencil hardness B, and the pencil hardness F may be harder than the pencil hardness B.

When the pencil hardness value of the protective layer does not satisfy the above range, scratches may occur on the surface of the protective layer during module processing. Therefore, because a carrier film in this case must be present on the protective layer, there may be limitations in terms of process efficiency.

When the water contact angle of the protective layer is less than 90°, there may be a problem that scratches may easily occur due to external impact and/or contact because the protective layer has insufficient slipperiness. When the water contact angle of the protective layer is greater than 100°, there may be a problem that an unreacted leveling agent is precipitated under durability reliability (60 °C.×95%×500 hours) conditions because an excessive amount of leveling agent is used.

As described in more detail herein below, the protective layer may be formed to face the adhesive film. The protective layer may secure or improve the scratch resistance of the adhesive protective film both (e.g., simultaneously) before and after light irradiation if (e.g., when) the protective layer has a pencil hardness value of F to H and a water contact angle value of 90° to 100° at 23 °C.

In one or more embodiments, the thickness of the protective layer may be determined or selected in consideration of the thickness of the substrate layer to be described herein below. For example, the thickness ratio of the substrate layer and the protective layer may be 10:1 to 200:1. When the thickness ratio of the substrate layer and the protective layer is set or selected to a set or predetermined range, scratches may be prevented or reduced from occurring during a module process and the protective layer may be prevented or reduced from breaking during a punching process. In some embodiments, the thickness ratio of the substrate layer and the protective layer may be 10:1 to 150:1, 10:1 to 140:1, or 10:1 to 130:1, but this is merely an example and embodiments are not limited thereto. From this perspective, the thickness of the protective layer may be, for example, 0.5 micrometers or more and less than 5.0 micrometers, 0.6 micrometers or more and less than 5.0 micrometers, 0.7 micrometers or more and less than 5.0 micrometers, 0.7 micrometers or more and less than 4.0 micrometers, or 0.7 micrometers or more and less than 3.0 micrometers. When the thickness of the protective layer is outside of the above range (e.g., greater than the above range), the adhesive protective film may break if (e.g., when) punched. If (e.g., when) the thickness of the protective layer is less than the above range, the pencil hardness of the protective layer may be reduced, which may deteriorate module processability.

### Adhesive Film

An adhesive film includes a (meth)acrylic copolymer, a curing agent, an aromatic group-containing monofunctional or higher monomer (e.g., monomer having one or more functional groups), and an initiator.

When the initial peel strength of the adhesive film with respect to the surface having polyimide-based ash is A, and the peel strength of the adhesive film with respect to the surface having the polyimide-based ash after the adhesive film is laminated on the surface having the polyimide-based ash and irradiated with light is B, the following Expression 1 may be satisfied:

A<B Expression 1

According to some embodiments, the adhesive film is adhered to a polyimide-based optical element having polyimide-based ash, and the peel strength is significantly increased after light irradiation compared to before light irradiation. Accordingly, the adhesive protective film having the adhesive film may not only serve as a temporary processing protective film in a flexible light-emitting element panel substrate, but also may be used as a pattern-reinforcing protective film after pattern formation.

In one or more embodiments, the adhesive film may have an initial peel strength of 7 gf/inch or less with respect to the surface having polyimide-based ash. Within the above range, the adhesive film may be adhered to a flexible light-emitting element panel substrate to protect the panel substrate and may serve as the temporary processing protective film because the adhesive film may be easily removed in the event of problems. For example, the initial peel strength may be greater than 0 gf/inch and less than or equal to 7 gf/inch, for example, 1 to 7 gf/inch, or 4 to 7 gf/inch. Here, the “initial peel strength” refers to the peel strength before the adhesive protective film is irradiated with light.

In one or more embodiments, the adhesive film may be laminated on a surface having the polyimide-based ash, and may have a peel strength of 200 gf/inch or more with respect to the surface having the polyimide-based ash after light irradiation. Within the above range, the adhesive film may be permanently laminated on a polyimide-based optical element having the polyimide-based ash, thereby enhancing durability reliability. For example, the adhesive film may have a peel strength of 300 gf/inch or more, for example, 300 to 600 gf/inch, after light irradiation.

Here, the “light irradiation” may include irradiating energy at 1,000 mJ/cm² with a wavelength of 280 nm to 430 nm, for example, a wavelength of 360 nm to 390 nm. UV irradiation may be performed using one or more selected from among a UV LED, a high-pressure mercury lamp, and a metal halide lamp.

Here, the “peel strength” may be measured at a peel temperature of 25 °C, a peel speed of 2,400 mm/min, and a peel angle of 180° using a tensile tester Texture Analyzer (TA Industry) according to JISZ2037 for the surface having polyimide-based ash.

In one or more embodiments, the adhesive film is a peel strength-enhancing adhesive film whose peel strength significantly increases after light irradiation compared to before light irradiation. Because the adhesive film has increased peel strength after light irradiation, the adhesive film is adhered to a polyimide-based optical element after light irradiation to provide a permanent protection aspect for the polyimide-based optical element. Therefore, the adhesive protective film having the adhesive film concurrently (e.g., simultaneously) performs temporary protection and permanent protection functions for the polyimide-based optical element, and thus may be used as both (e.g., simultaneously) a temporary processing protective film and a reinforcing protective film, thereby obtaining process simplification, economic efficiency and environmental friendliness effects. The temporary processing protective film may be a film that is temporarily adhered to an adherend and then removed, and may be a film that temporarily protects a polyimide-based optical element. The reinforcing protective film may be a film that is permanently adhered to a polyimide-based optical element to protect the polyimide-based optical element from an external environment, and/or the like, and cannot be removed from the polyimide-based optical element.

The adhesive protective film may be used as a reinforcing protective film. The reinforcing protective film refers to a protective film that is laminated on at least one side of a flexible panel to protect the flexible panel from external impacts, and/or the like.

In one or more embodiments, the adhesive film may have a peel strength increase rate of 50 or more, which is a ratio of B to A as defined in Expression 1 above. Within this range, the adhesive film may be adhered to a polyimide-based optical element and then adhered to the polyimide-based optical element with suitably high peel strength and suitably high reliability after light irradiation, thereby achieving an adhesive aspect on the polyimide-based optical element.

The adhesive film may include a cured product of a composition for an adhesive film including a (meth)acrylic copolymer, a curing agent, an aromatic group-containing monofunctional or higher monomer, and an initiator. In one or more embodiments, the cured product may be a thermally cured product.

In one or more embodiments, the adhesive film may have an aromatic group-containing monofunctional or higher monomer and initiator dispersed in an adhesive protective film matrix formed by thermal curing of a (meth)acrylic copolymer and an isocyanate-based curing agent.

### (Meth)Acrylic Copolymer

A (meth)acrylic copolymer may form a matrix of the adhesive film and provide the initial peel strength of the adhesive film by curing using an isocyanate-based curing agent. The (meth)acrylic copolymer may also help improve the modulus and cohesiveness of the adhesive film together with the aromatic group-containing monofunctional or higher monomer after light irradiation.

The (meth)acrylic copolymer may have a glass transition temperature (Tg) of −10 °C or lower, for example, −60 °C to −20 °C. If the glass transition temperature of the (meth)acrylic copolymer is within the above range, the (meth)acrylic copolymer may help provide wettability (adhesion) to the polyimide-based optical element and the initial peel strength of the adhesive film. After light irradiation, shrinkage of the adhesive film may be suppressed or reduced by controlling the glass transition temperature compared to an oligomer formed of a monofunctional or higher monomer, thereby increasing peel strength.

The (meth)acrylic copolymer may have a weight average molecular weight of 500,000 g/mol or more, for example, 600,000 to 1,500,000 g/mol. If the weight average molecular weight of the (meth)acrylic copolymer is within the above range, the (meth)acrylic copolymer may help provide wettability (adhesion) to an adherend and the initial peel strength of the adhesive film.

Here, the glass transition temperature may be measured by any suitable method using differential scanning calorimetry (DSC), and the weight average molecular weight may be calculated as a polystyrene conversion value by gel permeation chromatography.

The (meth)acrylic copolymer may include a copolymer of a monomer mixture including an alkyl group-containing (meth)acrylic monomer and a hydroxyl group-containing (meth)acrylic monomer.

The alkyl group-containing (meth)acrylic monomer forms a matrix of the adhesive protective film, and may include an unsubstituted alkyl group-containing (meth)acrylic acid ester having 1 to 20 carbon atoms, for example, 2 to 11 carbon atoms.

For example, the (meth)acrylic monomer having an alkyl group may include one or more selected from among methyl (meth)acrylate, ethyl (meth)acrylate, propyl (meth)acrylate, n-butyl (meth)acrylate, t-butyl (meth)acrylate, isobutyl (meth)acrylate, pentyl (meth)acrylate, hexyl (meth)acrylate, heptyl (meth)acrylate, ethylhexyl (meth)acrylate, octyl (meth)acrylate, isooctyl (meth)acrylate, nonyl (meth)acrylate, decyl (meth)acrylate, and lauryl (meth)acrylate.

The alkyl group-containing (meth)acrylic monomer may be included in the monomer mixture in an amount of 85 mol % to 99.5 mol %, for example, 90 mol % to 98 mol %, or 95 mol % to 99 mol %. In any of the above ranges, suitable wettability to an adherend and the initial peel strength of the adhesive film may be attained.

The hydroxyl group-containing (meth)acrylic monomer may be a (meth)acrylate containing one or more hydroxyl groups. For example, hydroxyl group-containing (meth)acrylates may include one or more selected from among 2-hydroxyethyl (meth)acrylate, 3-hydroxypropyl (meth)acrylate, 4-hydroxybutyl (meth)acrylate, hydroxyhexyl (meth)acrylate, 1,4-cyclohexanedimethanol mono(meth)acrylate, 1-chloro-2-hydroxypropyl (meth)acrylate, diethylene glycol mono(meth)acrylate, 1,6-hexanediol mono(meth)acrylate, pentaerythritol tri(meth)acrylate, dipentaerythritol penta(meth)acrylate, neopentyl glycol mono(meth)acrylate, trimethylolpropane di(meth)acrylate, trimethylolethane di(meth)acrylate, 2-hydroxy-3-phenyloxypropyl (meth)acrylate, 4-hydroxycyclopentyl (meth)acrylate, 4-hydroxycyclohexyl (meth)acrylate, and cyclohexanedimethanol mono(meth)acrylate.

The hydroxyl group-containing (meth)acrylic monomer may be included in the monomer mixture in an amount of 0.1 mol % to 10 mol %, for example, 0.5 mol % to 10 mol %, 0.5 mol % to 5 mol %, 2 mol % to 10 mol %, or 1 mol % to 5 mol %. In any of the above ranges, the hydroxyl group-containing (meth)acrylic monomer may effectively or suitably provide cohesiveness to the adhesive film to form an adhesive film and provide the initial peel strength of the adhesive film.

The monomer mixture may include a (meth)acrylic monomer having a homopolymer glass transition temperature of −80 °C or higher and 0 °C or lower, for example, −60 °C to −20 °C. If the glass transition temperature is within the above range, it may be easy or possible to manufacture a (meth)acrylic copolymer having the above-described glass transition temperature range.

In one or more embodiments, the monomer mixture may include a (meth)acrylic monomer having a homopolymer glass transition temperature of −80 °C or higher and 0 °C or lower, for example, −60 °C to −20 °C, in an amount of 90 mol % or more, for example, 95 mol % or more, or 95 to 99 mol %, of the monomer mixture. In this range, the effects of the present disclosure described above may be easily or suitably achieved. Such (meth)acrylic monomer may be n-butyl acrylate, and/or the like.

In one or more embodiments, the monomer mixture may not include (e.g., may exclude) a monomer having an aromatic group. An adhesive protective film manufactured from a (meth)acrylic copolymer formed of a monomer having an aromatic group may have difficulty reaching the peel strength increase rate described above.

In one or more embodiments, the sum (e.g., combination) of the alkyl group-containing (meth)acrylic monomer and the hydroxyl group-containing (meth)acrylic monomer included in the monomer mixture may be 99 mol % or more, for example, 99 to 100 mol %, or 100 mol %.

The (meth)acrylic copolymer may be manufactured by polymerizing the monomer mixture using any suitable polymerization method. The polymerization method may include methods suitable in the art. For example, the (meth)acrylic copolymer may be manufactured by adding an initiator to the monomer mixture and then subjecting the resulting mixture to a copolymer polymerization method, such as suspension polymerization, emulsion polymerization, solution polymerization, and/or the like. The polymerization temperature may be 60 °C to 70 °C, and the polymerization time may be 4 hours to 8 hours. An initiator including an azo-based polymerization initiator; and/or a peroxide such as benzoyl peroxide and/or acetyl peroxide may be used as the initiator.

### Curing Agent

A curing agent may help thermally cure the (meth)acrylic copolymer to form a matrix of the adhesive film and provide the initial peel strength of the adhesive film.

The curing agent may include an isocyanate-based curing agent as a thermal curing agent, and the isocyanate-based curing agent may be included in an amount of 0.1 to 20 parts by weight based on 100 parts by weight of the (meth)acrylic copolymer. For example, the isocyanate-based curing agent may be included in an amount of 6 to 20 parts by weight, 7 to 20 parts by weight, 7 to 10 parts by weight, 8 to 15 parts by weight, or 8 to 10 parts by weight based on 100 parts by weight of the (meth)acrylic copolymer.

The isocyanate-based curing agent may include a bifunctional or higher isocyanate-based curing agent (e.g., an isocyanate-based curing agent having two or more functional groups), for example, a bifunctional to hexafunctional isocyanate-based curing agent. In one or more embodiments, the isocyanate-based curing agent may include one or more selected from among xylene diisocyanate (XDI) including m-xylene diisocyanate and/or the like, methylene bis(phenyl isocyanate) (MDI) including 4,4′-methylene bis(phenyl isocyanate) and/or the like, naphthalene diisocyanate, tolylene diisocyanate, hexamethylene diisocyanate, isophorone diisocyanate, and/or an adduct thereof. For example, the adduct may be a trimethylolpropane adduct of tolylene diisocyanate, a trimethylolpropane adduct of hexamethylene diisocyanate, a trimethylolpropane adduct of isophorone diisocyanate, a trimethylolpropane adduct of xylene diisocyanate, an isocyanurate adduct of tolylene diisocyanate, an isocyanurate adduct of hexamethylene diisocyanate, and/or an isocyanurate adduct of isophorone diisocyanate. One or more isocyanate-based curing agents may be included in at least one of the compositions.

The curing agent may further include a metal chelate-based curing agent.

In one or more embodiments, the isocyanate-based curing agent and the metal chelate-based curing agent may be included in a weight ratio of 5:1 to 10:1, for example, 6:1 to 10:1. If the ratio is within the above range, the effects of the adhesive film may be easily or suitably achieved.

A suitable metal chelate-based curing agent may be used as the metal chelate-based curing agent. In this case, the metal chelate-based curing agent may include a curing agent including a metal such as aluminum, titan, iron, copper, zinc, tin, titanium, nickel, antimony, magnesium, vanadium, chromium, zirconium, and/or the like. For example, the metal chelate-based curing agent may include one or more selected from among aluminum ethylacetoacetate diisopropylate, aluminum tris(ethyl acetoacetate), an alkylacetoacetate aluminum diisopropylate, aluminum isopropylate, mono-sec-butoxyaluminum diisopropylate, aluminum-sec-butyrate, aluminum ethylate, tetraisopropyl titanate, tetra-n-butyl titanate, a butyl titanate dimer, titanium acetylacetonate, titanium octylene glycolate, titanium tetraacetylacetonate, titanium ethylacetoacetate, polyhydroxy titanium stearate, and aluminum acetylacetonate.

The metal chelate-based curing agent may be included in an amount of 3 parts by weight or less, for example, 0.001 parts by weight to 1 part by weight, and in some embodiments, 0.01 part by weight to 1 part by weight, based on 100 parts by weight of the (meth)acrylic copolymer. Within any of the above ranges, additional beneficial effects may be achieved without a substantial reduction in the effects of the adhesive film of the present disclosure.

The curing agent, for example, a mixture of the isocyanate-based curing agent and the metal chelate-based curing agent, may be included in an amount of 8 parts by weight to 20 parts by weight, for example, 8.5 parts by weight to 15 parts by weight, and in some embodiments, 8.5 parts by weight to 10.5 parts by weight, or 8.5 parts by weight to 10 parts by weight, based on 100 parts by weight of the (meth)acrylic copolymer. In any of the above ranges, the reliability of the adhesive film may be enhanced.

### Aromatic Group-Containing Monofunctional or Higher Monomer

An aromatic group-containing monofunctional or higher monomer (e.g., a monomer having one or more functional groups) has an aromatic group and one or more functional groups capable of reacting with an initiator. The term “aromatic” may refer to a monocyclic or heterocyclic functional group having 6 to 50 carbon atoms. For example, the term “aromatic” may refer to a substituted or unsubstituted benzyl group, phenyl group, biphenyl group, terphenyl group, naphthalenyl group, and/or the like. Also, the term “functional group” may refer to a vinyl group and/or a (meth)acrylate group that may be effective or suitable in preventing or reducing excessive shrinkage of the adhesive film if (e.g., when) cured by light irradiation.

The aromatic group-containing monofunctional or higher monomer contains an aromatic group, and thus may contribute to improving the adhesive strength of the adhesive film to an adherend by increasing the attractive force between the adhesive film and the polyimide-based film through the stacking aspect via TT-TT bonding with the adherend, for example, a plastic film having an aromatic group, such as a polyimide-based film. Also, the aromatic group is a relatively bulky substituent if (e.g., when) compared to a linear or branched alkyl group, and may contribute to suppressing or reducing an excessive increase in the initial peel strength of the adhesive film to the adherend if (e.g., when) the aromatic group is inserted between the (meth)acrylic copolymer and a network-type or kind cured product of the curing agent, for example, an interpenetrating polymer network (IPN) structure and/or a semi-IPN structure before light irradiation.

The aromatic group-containing monofunctional or higher monomer may increase the cohesiveness and/or modulus of the adhesive film after light irradiation. Therefore, if (e.g., when) the adhesive film is cured with light in a state in which the adhesive film is adhered to the surface of the adherend, the peel strength of the adhesive film may be increased by allowing the adhesive film to adhere to the adherend with a higher peel strength.

According to one or more embodiments, the glass transition temperature of the homopolymer of the aromatic group-containing monofunctional or higher monomer has a set or predetermined range compared to the glass transition temperature of the (meth)acrylic copolymer. Accordingly, even if (e.g., when) the adhesive film is cured by light irradiation, shrinkage of the adhesive film may be suppressed or reduced, thereby increasing the peel strength after light irradiation. The glass transition temperature of the homopolymer of the aromatic group-containing monofunctional or higher monomer is higher than the glass transition temperature of the (meth)acrylic copolymer, and the difference therebetween may be 20 °C or more, for example, 20 °C. to 120 °C, or 40 °C to 100 °C. In any of the above ranges, an increase in peel strength after light irradiation may be expected.

The aromatic group-containing monofunctional or higher monomer may have a homopolymer glass transition temperature of 6 °C or higher, for example, 6 °C to 50 °C. If the homopolymer glass transition is within the above range, because the glass transition temperature is higher than that of the (meth)acrylic copolymer, it is possible to achieve an aspect of improving the peel strength of the adhesive film by improving the cohesiveness after light irradiation.

The aromatic group-containing monofunctional or higher monomer may include a compound of the following Chemical Formula 1, but the present disclosure is not limited thereto:

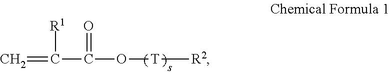

wherein:
R¹ is hydrogen or a methyl group, s is an integer from 0 to 10, R² is a substituted or unsubstituted aryl group having 6 to 50 carbon atoms or a substituted or unsubstituted aryloxy group having 6 to 50 carbon atoms, and T is a substituted or unsubstituted alkylene group having 1 to 6 carbon atoms or a substituted or unsubstituted alkyleneoxy group having 1 to 6 carbon atoms.

In the present specification, the term “substituted” in “substituted or unsubstituted” refers to a functional group in which one or more hydrogen atoms are substituted with an alkyl group having 1 to 10 carbon atoms, a thioalkyl group having 1 to 10 carbon atoms, an alkoxy group having 1 to 10 carbon atoms, a halogen (F, CI, Br, and/or I), a cycloalkyl group having 3 to 10 carbon atoms, and/or an aryl group having 6 to 20 carbon atoms.

For example, R² may be a substituted or unsubstituted phenoxy group, benzyl group, phenyl group, biphenyl group, terphenyl group, naphthyl group, and/or the like. For example, the aromatic group-containing monofunctional or higher monomer may include one or more selected from among phenoxy (meth)acrylate, 2-ethylphenoxy (meth)acrylate, benzyl (meth)acrylate, phenyl (meth)acrylate, 2-ethylthiophenyl (meth)acrylate, 2-phenylethyl (meth)acrylate, 3-phenylpropyl (meth)acrylate, 4-phenylbutyl (meth)acrylate, 2-(2-methylphenyl)ethyl (meth)acrylate, 2-(3-methylphenyl)ethyl (meth)acrylate, 2-(4-methylphenyl)ethyl (meth)acrylate, 2-(4-propylphenyl)ethyl (meth)acrylate, 2-(4-(1-methylethyl)phenyl)ethyl (meth)acrylate, 2-(4-methoxyphenyl)ethyl (meth)acrylate, 2-(4-cyclohexylphenyl)ethyl (meth)acrylate, 2-(2-chlorophenyl)ethyl (meth)acrylate, 2-(3-chlorophenyl)ethyl (meth)acrylate, 2-(4-chlorophenyl)ethyl (meth)acrylate, 2-(4-bromophenyl)ethyl (meth)acrylate, 2-(3-phenylphenyl)ethyl (meth)acrylate, orthobiphenyl (meth)acrylate, metabiphenyl (meth)acrylate, parabiphenyl (meth)acrylate, 2,6-terphenyl (meth)acrylate, orthoterphenyl (meth)acrylate, metaterphenyl (meth)acrylate, paraterphenyl (meth)acrylate, 4-(4-methylphenyl)phenyl (meth)acrylate, 4-(2-methylphenyl)phenyl (meth)acrylate, 2-(4-methylphenyl)phenyl (meth)acrylate, 2-(2-methylphenyl)phenyl (meth)acrylate, 4-(4-ethylphenyl)phenyl (meth)acrylate, 4-(2-ethylphenyl)phenyl (meth)acrylate, 2-(4-ethylphenyl)phenyl (meth)acrylate, and 2-(2-ethylphenyl)phenyl (meth)acrylate, which may be included alone or in combination of two or more.

In one or more embodiments, the aromatic group-containing monofunctional or higher monomer may include at least one selected from among benzyl (meth)acrylate, ethoxylated phenyl acrylate (phenyl(EO)1 acrylate, Phenyl(EO)2 acrylate), ethoxylated phenylphenol acrylate (o-phenylphenol(EO) acrylate), phenoxy benzyl acrylate, biphenylmethyl acrylate, and naphthyl acrylates including 1-naphthyl acrylate, and/or the like.

In one or more embodiments, phenoxy benzyl (meth)acrylate may be used.

The aromatic group-containing monofunctional or higher monomer may be included in an amount of 120 parts by weight or more, for example, 120 to 150 parts by weight, or 120 to 130 parts by weight, based on 100 parts by weight of the (meth)acrylic copolymer. In any of the above ranges, the aromatic group-containing monofunctional or higher monomer may contribute to increasing the peel strength of the adhesive film after light irradiation and may suppress or reduce shrinkage of the adhesive film.

### Initiator

An initiator may provide a physical change in the adhesive film during light irradiation by curing an aromatic group-containing monofunctional or higher monomer. The initiator may include one or more selected from among a photoradical initiator and a cationic photoinitiator, and may further include a thermal initiator.

In one or more embodiments, the initiator may include a photoinitiator having a maximum absorption wavelength within the irradiation wavelength range applied during the above-described light irradiation. For example, the initiator may have a maximum absorption wavelength at a wavelength of 280 nm to 430 nm. If the initiator has a maximum absorption wavelength within the above range, the photocuring aspect on the aromatic group-containing monofunctional or higher monomer may be achieved during the light irradiation. For example, the initiator may include a phosphorus-based initiator, a ketone-based initiator, and/or the like, but the present disclosure is not limited thereto.

The initiator may be included in an amount of 0.01 parts by weight to 7.5 parts by weight, for example, 0.03 parts by weight to 4.5 parts by weight, based on 100 parts by weight of the (meth)acrylic copolymer. When the initiator amount is within any of the above ranges, a substantially uniform curing of the aromatic group-containing monofunctional or higher monomer during light irradiation may be achieved, and a decrease in transparency of the adhesive film due to a residual amount of the initiator may be prevented or reduced.

The composition for an adhesive film may further contain a curing accelerator.

The curing accelerator may help the curing reaction of the adhesive film, thereby further increasing the cohesiveness of the adhesive film. The curing accelerator may include a curing accelerator suitable in the art. Examples thereof include a tin-based metal compound, a zinc metal compound, an amine compound, a titanium-based metal compound, a bismuth-based metal compound, and/or an aluminum-based metal compound. Among these, the tin-based metal compound may be used. Examples thereof include tetravalent or divalent organotin-based compounds such as dibutyltin dilaurate, bis-acetylacetonate-dibutyltin, dibutyltin dimaleate, tin dimaleate, and/or the like, but the present disclosure is not limited thereto.

The curing accelerator may be included in an amount of 0.001 parts by weight to 3 parts by weight based on 100 parts by weight of the (meth)acrylic copolymer. If the amount of the curing accelerator is within the above range, the curing accelerator may help increase the curing speed of the adhesive film and improve the cohesiveness of the adhesive film.

The composition for an adhesive film may further include a silane coupling agent.

The silane coupling agent may further increase the peel strength of the adhesive protective film. The silane coupling agent may include one or more suitable silane coupling agents in the art. For example, the silane coupling agent may include epoxy group-containing silane coupling agents such as glycidoxypropyltrimethoxysilane, glycidoxypropylmethyldimethoxysilane, and/or the like, but the present disclosure is not limited thereto.

The silane coupling agent may be included in an amount of 0.01 parts by weight to 5 parts by weight based on 100 parts by weight of the (meth)acrylic copolymer. If the amount of the silane coupling agent is within the above range, the peel strength-improving aspect may be further enhanced.

The composition for an adhesive film may further include an additive. The additive may include one or more suitable additives that can be included in the adhesive film. For example, the additive may include one or more selected from among a pigment, an ultraviolet absorber, an antioxidant, a leveling agent, an antistatic agent, a retardant, a catalyst, and a reworking agent, but the present disclosure is not limited thereto.

The composition for an adhesive film may further include a solvent. The solvent may increase the coating properties of the composition to provide an adhesive protective film having a suitably thin thickness and a substantially uniform surface. The solvent may include one or more types (kinds) of suitable solvents in the art. For example, the solvent may include methyl ethyl ketone, methyl isobutyl ketone, ethyl acetate, toluene, and/or the like, but the present disclosure is not limited thereto. In one or more embodiments, the composition may include the adhesive protective film at a solid content (e.g., amount) of 15% by weight to 40% by weight, specifically 20% by weight to 30% by weight. If the solid content of the adhesive protective film is within the above range, the composition may have excellent or suitable coating properties.

The adhesive film may have a thickness of 200 μm or less, for example, more than 0 μm and less than 100 μm, and in some embodiments, 5 μm to 50 μm. If the thickness of the adhesive film is within the above range, the adhesive film may help provide a protective aspect on the flexible panel.

### Substrate Layer

A substrate layer supports the adhesive protective film.

The substrate layer may be a film including an optically transparent resin. In one or more embodiments, the resin may include a film including a polyester-based film including a polyethylene terephthalate-based film, a polyethylene naphthalate-based film, and/or the like, a polycarbonate-based film, a polyether sulfone-based film, and/or the like.

The substrate layer may have a thickness of 200 μm or less, for example, more than 0 μm and less than 100 μm, and in some embodiments, 5 μm to 75 μm, or 5 μm to 50 μm. If the thickness of the substrate is within the above range, the substrate layer may help provide a protective aspect on the flexible panel.

The adhesive protective film may have a haze of 5% or less, for example, 0.1% to 2%, and a total light transmittance of 80% or more, for example, 85% to 95% in the visible light region (e.g., a wavelength of 380 nm to 780 nm). If the haze and total light transmittance are within their respective above ranges, the adhesive protective film may be used in an optical display apparatus due to the good or suitable optical transparency.

The adhesive protective film may further include a release film formed on one surface of the adhesive film. The release film may serve to protect the adhesive film from external foreign substances. Any suitable type (kind) of material may be used as the release film.

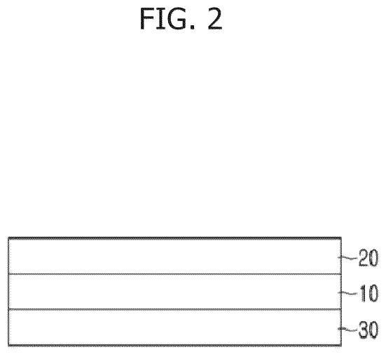

FIG. 2 is a cross-sectional view of an adhesive protective film according to one or more embodiments.

Referring to FIG. 2, the adhesive protective film may include a substrate layer 10, an adhesive film 20 laminated on a first surface of the substrate layer 10, and a protective layer 30 laminated on a second surface of the substrate layer 10.

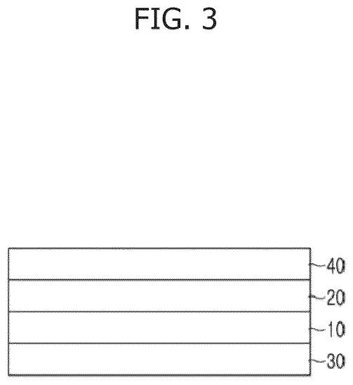

FIG. 3 is a cross-sectional view of an adhesive protective film according to one or more other embodiments.

Referring to FIG. 3, the adhesive protective film may include a substrate layer 10; an adhesive film 20 and a release film 40 sequentially laminated on a first surface of the substrate layer 10; and a protective layer 30 laminated on a second surface of the substrate layer 10.

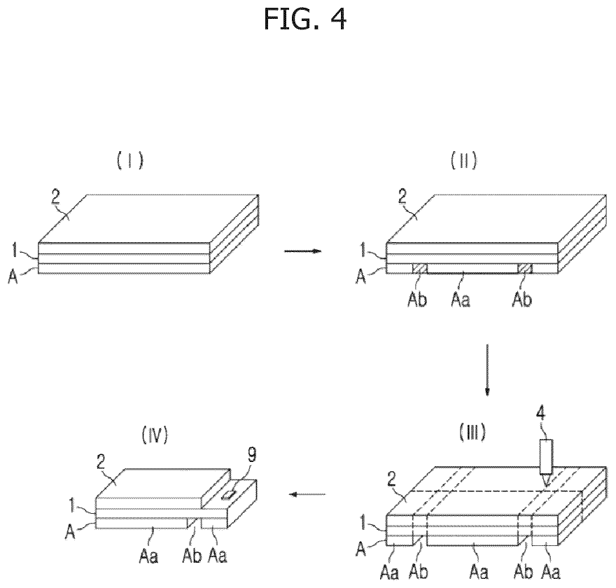

FIG. 4 is a diagram illustrating a part of a process of assembling a panel for an optical display apparatus using the adhesive protective film according to one or more embodiments.

Referring to FIG. 4, a temporary upper protective film 2 and an adhesive protective film A according to one or more embodiments are laminated on the upper and lower surfaces of a panel 1 (e.g., a polyimide-based panel) having an OLED light-emitting element formed thereon, respectively, to manufacture a laminate (I).

The adhesive protective film A is patterned into a portion Aa remaining in the laminate and a portion Ab peeled off of the laminate by patterning the laminate using a laser (II).

The portion Ab peeled off of the laminate is peeled off, irradiated with light, and then cut with a laser 4 to separate the portions (III).

A laminate (a temporary upper protective film 2 and a portion Aa remaining in the laminate, which are respectively formed on the upper and lower surfaces of a panel 1 having an OLED light-emitting element formed thereon) having a small size is obtained, and then a display driver 9 is mounted to manufacture a panel (IV).

Next, a method of manufacturing a polyimide-based layer having a surface having the polyimide-based ash is described.

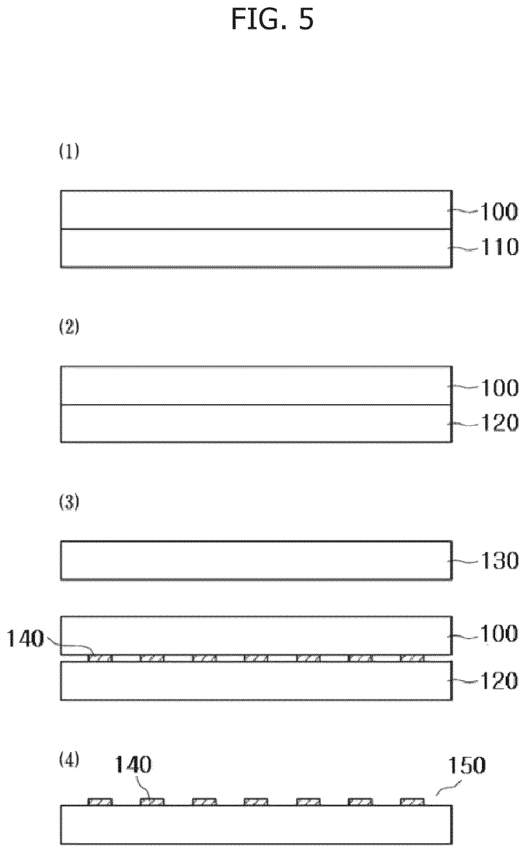

FIG. 5 illustrates an example embodiment of a method of manufacturing a polyimide-based layer having polyimide-based ash.

Referring to FIG. 5, (1) a polyimide-based varnish is applied to a set or predetermined thickness on a lower surface of a glass plate 100 to manufacture a polyimide-based varnish coating film 110.

(2) The manufactured polyimide-based varnish coating film 110 is dried and cured to form a polyimide-based layer 120 on the lower surface of the glass plate 100.

(3) When a laser is irradiated on the upper side of the glass plate 100 using a laser irradiation device 130, polyimide-based ash 140 is formed on the upper surface of the polyimide-based layer 120.

The laser irradiation may form polyimide-based ash by burning a portion of the polyimide-based layer 120. The polyimide-based ash may form a fine step (e.g., a small stepped portion) between the laser-treated part and the non-laser-treated part as an irregular fine unevenness in the form of dust. The step (e.g., the stepped portion) may facilitate peeling of the glass plate in step (e.g., act or task) (4) described herein below. The degree of formation of the polyimide-based ash 140 and/or the area ratio in which the polyimide-based ash 140 is formed (the total area ratio of the polyimide-based ash to the total area of the polyimide-based layer) may be controlled or selected depending on the type or kind of polyimide-based varnish, the total thickness of the polyimide-based layer, the degree of laser irradiation, and/or the like.

(4) The glass plate 100 may peeled off of the polyimide-based layer 120 to manufacture a polyimide-based layer 150 having a surface having the polyimide-based ash 140.

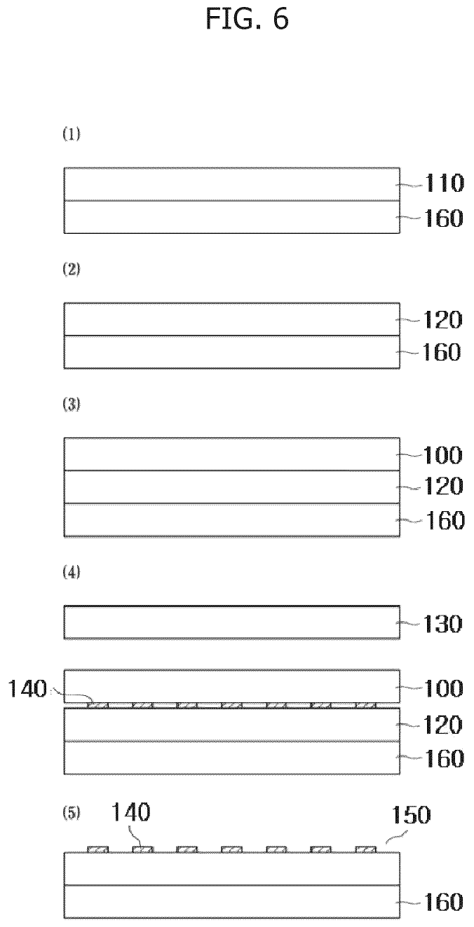

FIG. 6 illustrates another example embodiment of a method of manufacturing a polyimide-based layer having polyimide-based ash.

Referring to FIG. 6, (1) a polyimide-based varnish is applied to a set or predetermined thickness to the upper surface of a release substrate film 160 to manufacture a polyimide-based varnish coating film 110.

(2) The manufactured polyimide-based varnish coating film 110 is dried and cured to form a polyimide-based layer 120 on the upper surface of the release substrate film 160.

(3) The upper surface of the polyimide-based layer 120 is covered with a glass plate 100.

(4) When a laser is irradiated on the upper side of the glass plate 100 using a laser irradiation device 130, polyimide-based ash 140 is formed on the upper surface of the polyimide-based layer 120. The laser treatment may form polyimide-based ash by burning a portion of the polyimide-based layer. The polyimide-based ash may form a fine step (e.g., a small stepped portion) between the laser-treated part and the non-laser-treated part as an irregular fine unevenness in the form of dust. The step (e.g., the stepped portion) may facilitate peeling of the glass plate in step (e.g., act or task) (5) herein below. The degree of formation of the polyimide-based ash 140 and/or the area ratio in which the polyimide-based ash 140 is formed (the total area ratio of the polyimide-based ash to the total area of the polyimide-based layer) may be controlled or selected depending on the type or kind of polyimide-based varnish, the total thickness of the polyimide-based layer, the degree of laser irradiation, and/or the like.

(5) The glass plate 100 is peeled off of the polyimide-based layer 120 to manufacture a laminate of the release substrate film 160 and the polyimide-based layer 150 having a surface having polyimide-based ash 140.

The release substrate film 160 may be easily removed because the release substrate film 160 is release-treated with silicone and/or the like.

The glass plate may be an alkali-free glass plate and may have a thickness of 1 to 2 mm.

The polyimide-based varnish may include 90% by weight or more of one or more selected from among a polyimide-based copolymer, a polyimide-based oligomer, and a polyimide-based monomer, but the present disclosure is not limited thereto. For example, SD Flex (DuPont) may be used as the polyimide-based varnish, but the present disclosure is not limited thereto.

The polyimide-based varnish may be applied by a method suitable in the art. For example, the polyimide-based varnish may be applied by a doctor blade coating method. At this time, the gauge diameter may be 0.5 to 1.0 mm, for example, 0.65 mm. The polyimide-based varnish may be applied to a thickness of 10 to 30 μm.

The polyimide-based varnish coating film may be dried and cured to become a polyimide-based layer.

The drying may include a heat treatment at 50 to 200 °C for 5 minutes to 60 minutes. The drying may include one or more heat treatments, for example, two or more heat treatments. In one or more embodiments, the drying may include two or more heat treatments. For example, the drying may include a first heat treatment at 50 to 100 °C for 5 minutes to 30 minutes and a second heat treatment at 100 to 200 °C for 5 minutes to 30 minutes. In one or more embodiments, the first heat treatment may be performed at 80 °C for 10 minutes, and the second heat treatment may be performed at 120 °C for 20 minutes.

The dried product of the polyimide-based varnish coating film may have a thickness of 20 to 30 μm, for example, a thickness of 20 μm.

The curing may include heat treatment at a relatively high temperature for a relatively longer period of time compared to the drying. This heat treatment may imidize a dried product of the polyimide-based varnish coating film to manufacture a polyimide-based layer. The heat treatment may include heat treatment at a temperature of more than 200 °C and less than or equal to 400 °C for 30 minutes to 120 minutes. In one or more embodiments, the heat treatment may be performed one or more times. In one or more embodiments, the curing may include heat treatment at 250 °C for 60 minutes.

The polyimide-based layer may have a thickness of 20 to 30 μm, for example, a thickness of 20 μm.

The laser irradiation may include irradiation with a light amount of 100 to 500 mJ/cm², for example, 150 to 200 mJ/cm². If the light amount is within the above range, a polyimide-based ash that is easily or suitably peeled off of the glass plate may be formed. The laser irradiation includes light irradiation at a wavelength of 308 nm, and may include picosecond, nanosecond and/or femtosecond irradiation.

One or more embodiments of the present disclosure are directed toward an optical member.

The optical member may include a polyimide-based optical element having polyimide-based ash on at least one surface, and an adhesive protective film laminated on the one surface having the polyimide-based ash, wherein the adhesive protective film includes a substrate layer, an optically cured product of an adhesive film laminated on a first surface of the substrate layer, and a protective layer laminated on a second surface of the substrate layer, and the protective layer contains a silicon-based compound and has a pencil hardness value of F to H and a water contact angle value of 90° to 100° at 23 °C.

The optical member may include an optically cured product of the above-described adhesive film.

In one or more embodiments, the polyimide-based optical element may be a flexible substrate. The flexible substrate may serve to support an optical element such as an organic light-emitting diode and/or the like.

Any suitable optical element may be further laminated on at least one surface of the polyimide-based optical element. Such an optical element may provide certain optical functions of the optical display apparatus, such as light emission, polarization, optical compensation, display image quality improvement, and/or conductivity. The optical element may include an OLED element, a window film, a window, a polarizing plate, a color filter, a phase difference film, an elliptically polarizing film, a reflective polarizing film, an anti-reflection film, a compensation film, a brightness-enhancing film, an alignment film, a light diffusion film, a glass scattering prevention film, a surface protection film, an OLED element barrier layer, a plastic LCD substrate, a transparent electrode film including indium tin oxide (ITO), fluorinated tin oxide (FTO), aluminum-doped zinc oxide (AZO), carbon nanotubes (CNTs), Ag nanowires, graphene, and/or the like.

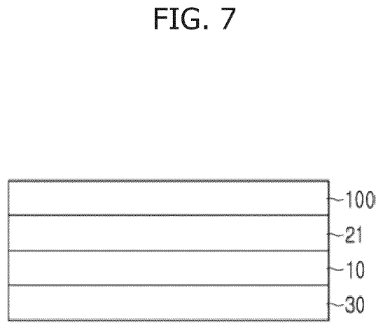

FIG. 7 is a cross-sectional view of an example embodiment of an optical member.

Referring to FIG. 7, the optical member includes a polyimide-based optical element 100 having polyimide-based ash on a lower surface, and an adhesive protective film laminated on the lower surface of the polyimide-based optical element 100, wherein the adhesive protective film may include a substrate layer 10, a cured product 21 of an adhesive film laminated on a first surface of the substrate layer 10, and a protective layer 30 laminated on a second surface of the substrate layer 10.

One or more embodiments of the present disclosure are directed to an optical display apparatus.

The optical display apparatus includes the optical member described above.

The optical display apparatus may include an organic light-emitting element display apparatus, a liquid crystal display apparatus, and/or the like. The optical display apparatus may include a flexible display apparatus. However, the optical display apparatus may also include a non-flexible display apparatus.

Hereinafter, the configuration and operation of the present disclosure will be described in more detail through embodiments of the present disclosure. However, it should be understood that these embodiments are presented as examples of the present disclosure and are not construed as limiting the present disclosure in any way.

### Example 1

### (1) Preparation of Composition for Adhesive Film

The solvent ethyl acetate was added to a 1 L reactor equipped with a cooling device for refluxing nitrogen gas and easily or suitably controlling the temperature. 100 parts by weight of a monomer mixture including 97 mol % of n-butyl acrylate (homopolymer glass transition temperature: −45 °C) and 3 mol % of 4-hydroxybutyl acrylate was added to the reactor. Nitrogen gas was input to the monomer mixture for 30 minutes to remove oxygen, and the internal temperature of the reactor was then maintained at 62 °C. The monomer mixture was uniformly (e.g., substantially uniformly) stirred, 0.07 parts by weight of the initiator azobisisobutyronitrile was added, and allowed to react at 62 °C for 8 hours to manufacture a (meth)acrylic copolymer (weight average molecular weight: 1 million g/mol). The solvent ethyl acetate was added to prepare a (meth)acrylic copolymer solution (solid content (e.g., amount): 24% by weight).

Based on the solid content, 0.9 part by weight of TD-75 (an isocyanate-based curing agent or an isocyanate-reactive curing agent; Soken; solid content (e.g., amount): 75% by weight) and 1.0 part by weight of BXX-4805 (an aluminum chelate-based curing agent; Samyoung Ink & Coatings; solid content (e.g., amount): 5% by weight) as curing agents, 28.8 parts by weight of phenoxybenzyl acrylate (homopolymer glass transition temperature: 6 °C; HanNong Chemicals Inc.) as an aromatic group-containing monofunctional monomer, and 0.6 part by weight of Irgacure TPO (BASF, a phosphorus-based photoinitiator) as a photoinitiator were added to 100 parts by weight of the (meth)acrylic copolymer manufactured in the preparation example in the contents shown in Table 1. Thereafter, methyl ethyl ketone was added and diluted to prepare a composition for an adhesive film (solid content (e.g., amount): 25% by weight).

### (2) Preparation of Composition for Protective Layer

A composition for a protective layer was prepared in the following order.

First, 60 parts by weight of urethane dimethacrylate (UDMA, Merck), 25.7 parts by weight of triethylene glycol dimethacrylate (TEGDMA, Merck), 3 parts by weight of the long-wavelength photoinitiator TPO (IGM Resins), and 1 part by weight of the short-wavelength photoinitiator 1-184 (IGM Resins) were dissolved in a solvent to prepare a basic composition A having a solid content (e.g., amount) of 50% by weight. Here, 45 parts by weight of each of methyl ethyl ketone (MEK) and toluene was used as the solvent.

As a leveling agent, 0.12% by weight of a silicon-based compound (BYK-UV 3505) was added to 100 parts by weight of the prepared basic composition A, and the total solid content (e.g., amount) in the composition for a protective layer was adjusted to 30% by weight by adjusting the amount of the solvent.

### (3) Manufacture of Adhesive Protective Film

A polyethylene terephthalate (PET) film (Mitsubishi Chemical Corporation (MCC), T914J75, thickness: 75 μm) was prepared as a substrate layer. One surface of the PET film was coated with the composition for a protective layer using a bar coater, dried at 85 °C for 2 minutes, and then exposed to 300 mJ/cm² (at UV-A) using a mercury lamp to form a 1 μm-thick protective layer.

Next, the prepared composition for an adhesive film was applied to a thickness of 13 μm on the other surface of the PET film, dried at 110 °C for 4 minutes. Thereafter, a release film (thickness: 25 μm, silicone release-treated on one surface, MHF25, MCC) was bonded to the obtained adhesive layer, and left at 50 °C for 3 days to manufacture a sheet including an adhesive protective film in which an adhesive film and a release film were sequentially laminated on the first surface of a substrate layer and a protective layer was formed on the second surface of the substrate layer.

### Examples 2 to 8

Sheets including an adhesive protective film were manufactured in substantially the same manner as in Example 1, except that the content (e.g., amount) of the silicon-based compound in the protective layer and/or the thickness of the protective layer were changed as shown in Table 1.

### Comparative Example 1

A sheet including an adhesive protective film was manufactured in substantially the same manner as in Example 1, except that 0.2% by weight of a compound containing an OH group (BYK-SILCLEAN 3700) was added instead of the silicon-based compound in the protective layer.

### Comparative Example 2

A sheet including an adhesive protective film was manufactured in substantially the same manner as in Example 1, except that 0.2% by weight content (e.g., amount) of a non-silicon compound containing an acryl group (BKK-UV3535) was used instead of the silicon-based compound in the protective layer.

Select physical properties of the sheets including the adhesive protective film manufactured in the examples and comparative examples were evaluated. The results are shown in Table 1.

### Reference Example: Manufacture of Polyimide-Based Layer Having Polyimide-Based Ash on One Surface

A polyimide-based layer having polyimide-based ash on one surface was manufactured.

A polyimide-based varnish (SD Flex, DuPont) was applied to a thickness of 20 μm on the upper surface of an alkali-free glass plate (thickness: 1.1 mm) using a doctor blade coating device (gauge diameter: 0.65 mm) to manufacture a polyimide-based varnish coating film.

The polyimide-based varnish coating film was thermally treated at 80 °C for 10 minutes and then at 120 °C for 20 minutes to manufacture a dried product (thickness: 20 μm) of the polyimide-based varnish coating film.

The dried product of the polyimide-based varnish coating film was cured in a high-temperature chamber at 250 °C for 60 minutes to manufacture a laminate of the polyimide-based layer (thickness: 20 μm) and a glass plate.

A laser irradiation device (Micro Lens Arrays (MicroLAS), COHERENT) was positioned on the upper side of the glass plate of the laminate, and a laser was irradiated while moving the laminate from one direction to the other. The laser irradiation conditions were a wavelength of 308 nm, femtoseconds, and a light intensity of 170 mJ/cm².

After the laminate was kept at room temperature for an hour, the glass plate was peeled off to manufacture a polyimide-based layer having polyimide-based ash on one surface.

### Measurement of Peel Strength of Adhesive Film

In the optical members manufactured in the examples and comparative examples, the manufactured polyimide-based layer having polyimide-based ash was laminated on the upper surface of the adhesive film, and pressed with a 2 kg roller to manufacture a specimen. At this time, the surface having polyimide-based ash and the adhesive film were laminated.

The specimen was cut into a size of 25 mm×100 mm in width×length. The specimen was left at 23 °C and a relative humidity of 50% for 30 minutes. Based on Japanese Industrial Standard JISZ2037, a tensile tester Texture Analyzer (TA Industry) was used to measure the peel strength A if (e.g., when) the adhesive film was peeled off of the surface having polyimide-based ash at a peel temperature of 25 °C, a peel speed of 2400 mm/min, and a peel angle of 180°.

Then, the specimen was irradiated with UV at a wavelength of 393 nm with an intensity of 1,000 mJ, and the peel strength B was measured using the same method.

As a result, it can be seen that the peel strength B was higher than the peel strength A.

### Scratch Resistance by Steel Wool Test:

In the sheets including the adhesive protective film manufactured in the examples and comparative examples, the release film was peeled off to expose the protective layer, and a polyimide film having a thickness of 50 μm and a glass plate having a thickness of 100 μm were sequentially laminated on the lower surface of the adhesive film to manufacture a specimen.

The manufactured specimen was positioned so that the protective layer faced upward, and the number of scratches occurring if (e.g., when) the specimen was reciprocated (e.g., moved forward and backward) five times at a reciprocating speed of 4,000 mm/min under a load of 5 N was then evaluated. When no scratches occurred, it was marked as ⊚, if (e.g., when) there were 1 to 5 scratches, it was marked as ◯, if (e.g., when) there were 6 to 20 scratches, it was marked as Δ, and if (e.g., when) there were more than 20 and less than 100 scratches, it was marked as X.

### Pencil Hardness

The pencil hardness of the sheets including the adhesive protective film manufactured in the examples and comparative examples was measured under the conditions of 23 °C and 50% relative humidity according to ASTM D3363 film hardness evaluation test. The specimen was cut to a size of 50 mm×50 mm, and an adhesive surface of the specimen was laminated on the glass plate. Then, the protective layer of the specimen was measured as the measurement area, and the pencil hardness was measured under 5 N at a speed of 48 mm/min.

### Water Contact Angle (Units: °) of Protective Layer:

The sheets including the adhesive protective film manufactured in the examples and comparative examples were cut to a size of 30 mm×100 mm to manufacture specimens. Among the specimens, the surface of the protective layer was placed on a contact angle measuring device (DSA100, KRÜSS Scientific) jig, and the water contact angle was then measured five times at 23 °C and 50% relative humidity to calculate the average value.

### Peel Strength of Carrier Film

In the sheets including the adhesive protective film manufactured in the examples and comparative examples, a carrier film was pressed on the protective layer using a 2 kg roll at 23 °C and 50% relative humidity, and then cut to a size of 25 mm×100 mm (width×length) to manufacture specimens. After manufacturing the specimens, the specimens were left for 30 minutes at 23 °C and 50% relative humidity. The peel strength if (e.g., when) the carrier film of the sheet was peeled at a peel speed of 2,400 mm/min at 25 °C was evaluated using a tensile tester (Texture Analyzer, TA Industry) according to JISZ2037.

### Punching Workability

In the sheets including the adhesive protective film manufactured in the examples and comparative examples, the protective layer was provided to face upward. Thereafter, the sheet was cut using a wooden mold under the conditions of a press pressure of 15 MPa and a speed of 5 m/min. The cross-section of the cut specimen was visually observed on all four sides regardless of the number, and the presence or absence of breakage and/or burrs on each side was evaluated.

The evaluation criteria are as follows.
⊚ (Excellent): No breakage or burrs on all four sides
∘ (Good): Breakage and/or burrs on one of the four sides
Δ (Average): Breakage and/or burrs on two of the four sides
x (Poor): Breakage and/or burrs on all four sides

### Reliability (60 °C×95%×500 hr)

An adhesive surface of each of the sheets including the adhesive protective film manufactured in the examples and comparative examples was laminated on an Ash PI surface, pressed using a 2 kg roll, and then cut to a size of 150 mm×90 mm.

Next, the cut sheet was left at 23 °C and 50% relative humidity for 30 minutes, and pressed. Thereafter, the substrate surface of the sheet was irradiated with 1,000 mJ/cm² through a UV exposure device to manufacture a specimen for evaluating durability reliability.

After the manufactured specimens were left for 500 hours under conditions of 60 °C×95%, the occurrence of bubbles, stains (migration), and/or the like was observed and evaluated.

### The Evaluation Criteria are as Follows:

⊚: No bubbles or stains at all
∘: 1 or fewer bubbles and/or stains
Δ: 3 or fewer bubbles and/or stains
x: More than 3 bubbles and/or stains

### Module Processability—S/C Defect Occurrence Rate (Units: %)

For the sheets including the adhesive protective film manufactured in the examples and comparative examples, the presence or absence of scratches and cracks (S/C) was confirmed by direct visual inspection during the process.

TABLE 1

| | | Example | Example | Example | Example | Example | Example | Example | Example | Comparative | Comparative |
|---|---|---|---|---|---|---|---|---|---|---|---|
| | | 1 | 2 | 3 | 4 | 5 | 6 | 7 | 8 | Example 1 | Example 2 |
| Protective | Content | 0.12 | 0.16 | 0.2 | 0.2 | 0.2 | 0.2 | 0.2 | 0.24 | — | — |
| layer | (wt %) | | | | | | | | | | |
| | of | | | | | | | | | | |
| | silicon- | | | | | | | | | | |
| | based | | | | | | | | | | |
| | compound | | | | | | | | | | |
| | Content | — | — | — | — | — | — | — | — | 0.2 | — |
| | (wt %) | | | | | | | | | | |
| | of | | | | | | | | | | |
| | OH | | | | | | | | | | |
| | group- | | | | | | | | | | |
| | containing | | | | | | | | | | |
| | compound | | | | | | | | | | |
| | Content | — | — | — | — | — | — | — | — | — | 0.2 |
| | (wt %) | | | | | | | | | | |
| | of | | | | | | | | | | |
| | non- | | | | | | | | | | |
| | silicon- | | | | | | | | | | |
| | based | | | | | | | | | | |
| | acryl | | | | | | | | | | |
| | group- | | | | | | | | | | |
| | containing | | | | | | | | | | |
| | compound | | | | | | | | | | |
| Thickness | | 1 | 1 | 0.7 | 1 | 1.5 | 2 | 3 | 1 | 1 | 1 |
| (μm) of | | | | | | | | | | | |
| protective | | | | | | | | | | | |
| layer | | | | | | | | | | | |
| Physical | Steel | ⊚ | ⊚ | ⊚ | ⊚ | ⊚ | ⊚ | ⊚ | ⊚ | X | X |
| properties | wool | | | | | | | | | | |
| | Pencil | F | F | F | F | F | 1H | 1H | 1H | B | 2B |
| | hardness | | | | | | | | | | |
| | Water | 94.2 | 95 | 95.6 | 95.9 | 96.1 | 96.3 | 96.4 | 97.5 | 90.2 | 75.8 |
| | contact | | | | | | | | | | |
| | angle | | | | | | | | | | |
| | Peel | 12.1 | 11.2 | 10.1 | 10.3 | 10.2 | 10.4 | 10.6 | 9.1 | 20.1 | 35.8 |
| | strength of | | | | | | | | | | |
| | carrier | | | | | | | | | | |
| | film | | | | | | | | | | |

| | | | | | | | | | | |
|---|---|---|---|---|---|---|---|---|---|---|
| Punching | ⊚ | ⊚ | ⊚ | ⊚ | ⊚ | ⊚ | ◯ | ⊚ | ⊚ | ⊚ |
| workability | | | | | | | | | | |
| Reliability | ⊚ | ⊚ | ⊚ | ⊚ | ⊚ | ⊚ | ⊚ | ⊚ | X | ◯ |
| S/C | 0 | 0 | 0 | 0 | 0 | 0 | 0 | 0 | 50 | 82 |
| occurrence | | | | | | | | | | |
| rate (%) | | | | | | | | | | |

As shown in Table 1 above, it can be seen that the adhesive protective films according to Examples 1 to 8 are superior in terms of punching workability, reliability, S/C occurrence rate compared to the adhesive protective films according to Comparative Examples. Also, it can be seen from the evaluation results of steel wool testing, pencil hardness, and water contact angle characteristics that the adhesive protective films according to Examples 1 to 8 have excellent or suitable scratch resistance. In one or more embodiments, it can be seen that the presence or absence of the carrier film may be selected during the process because the peel strength of the carrier film satisfies a set or predetermined level even if (e.g., when) the adhesive protective films are accompanied by the carrier film.

The present disclosure can provide an adhesive protective film that can be adhered to a polyimide-based optical element having polyimide-based ash, can have a significantly higher peeling strength after light irradiation than before light irradiation, and can be fixed to the optical element to increase the durability reliability of the optical element.

The present disclosure can provide an adhesive protective film that can be concurrently (e.g., simultaneously) used as a temporary processing protective film in a flexible light-emitting element panel substrate and as a pattern-reinforcing protective film having only a portion selectively peeled off to form a pattern.

The present disclosure can provide an adhesive protective film having excellent or suitable scratch resistance and excellent or suitable panel manufacturing processability using the adhesive protective film.

The foregoing is illustrative of some embodiments of the present disclosure, and is not to be construed as limiting thereof. Although some embodiments have been described, those skilled in the art will readily appreciate that various changes and modifications of the present disclosure can be easily implemented by those skilled in the art, and all such changes and modifications can be considered to be included in the scope of the present disclosure as defined in the appended claims, and their equivalents.

What is claimed is:

1. An adhesive protective film comprising:
a substrate layer;
an adhesive film on a first surface of the substrate layer; and
a protective layer on a second surface of the substrate layer,
wherein the adhesive film comprises a (meth)acrylic copolymer, a curing agent, an aromatic group-containing monofunctional or higher monomer, and an initiator, and
the protective layer comprises a silicon-based compound and has a pencil hardness value of F to H and a water contact angle value of 90° to 100° at 23 °C.

2. The adhesive protective film as claimed in claim 1, wherein a thickness ratio of the substrate layer and the protective layer is 10:1 to 200:1.

3. The adhesive protective film as claimed in claim 2, wherein the protective layer has a thickness of 0.5 micrometer or more and less than 5.0 micrometers.

4. The adhesive protective film as claimed in claim 1, wherein the protective layer is directly on the second surface of the substrate layer.

5. The adhesive protective film as claimed in claim 1, wherein the protective layer is formed by applying a composition for a protective layer on the second surface of the substrate layer and subjecting the composition for the protective layer to a curing process, and the composition for the protective layer comprises a binder and the silicon-based compound.

6. The adhesive protective film as claimed in claim 5, wherein the silicon-based compound is in an amount of 0.1 to 0.4% by weight with respect to the composition for the protective layer.

7. The adhesive protective film as claimed in claim 5, wherein the binder comprises one or more selected from among a urethane-based resin and a urethane (meth)acrylate-based resin.

8. The adhesive protective film as claimed in claim 1, further comprising a carrier film on the protective layer,
wherein the carrier film has a peel strength of 9 to 13 gf/inch.

9. The adhesive protective film as claimed in claim 1, further comprising a release film on one surface of the adhesive film,
wherein the adhesive film is between the release film and the substrate layer.

10. The adhesive protective film as claimed in claim 1, wherein if an initial peel strength of the adhesive film with respect to a surface comprising a polyimide-based ash is A, and a peel strength of the adhesive film with respect to the surface comprising the polyimide-based ash after the adhesive film is laminated on the surface having the polyimide-based ash and irradiated with light is B, then Expression 1 is satisfied:
A<B. Expression 1

11. An optical member comprising:
a polyimide-based optical element comprising a polyimide-based ash on at least one surface, and
an adhesive protective film on the one surface comprising the polyimide-based ash,
wherein the adhesive protective film comprises a substrate layer, an adhesive film on a first surface of the substrate layer, and a protective layer on a second surface of the substrate layer,
the adhesive film comprises a cured product of a composition comprising a (meth)acrylic copolymer, a curing agent, an aromatic group-containing monofunctional or higher monomer, and an initiator, and
the protective layer comprises a silicon-based compound and has a pencil hardness value of F to H and a water contact angle value of 90° to 100° at 23 °C.

12. An optical display apparatus comprising the optical member of claim 11.
